(19) United States
(12) Patent Application Publication
(10) Pub. No.: US 2010/0139006 A1
(43) Pub. Date: Jun. 10, 2010

(54) Suspension Pocket Spring System

(75) Inventor: Ersen Kilic, Istanbul (TR)

Correspondence Address: AKERMAN SENTERFITT, P.O. BOX 3188, WEST PALM BEACH, FL, 33402-3188, US

(73) Assignee: Sipahioglu Celik Yay Ve Yan Urunleri Sanayi Ve Ticaret Limited Sirketi, Istanbul (TR)

(21) Appl. No.: 12/525,769

(22) PCT Filed: Aug. 24, 2007
(86) PCT No.: PCT/TR2007/000082

§ 371 Date: Aug. 4, 2009

(51) Int. Cl. A47C 27/07; A47C 27/06; B68G 7/00

(52) U.S. Cl. 5/720; 29/91.1

(57) ABSTRACT

The invention relates to a suspension pocketed spring system containing steps of manufacture of standard pocketed springs (10) manufactured for use in inner construction systems used to provide flexibility between platforms/layers where to be located and separate connection of short pocketed springs (20) to each other in a manner to form a space (23) and manufacture method of it

### TECHNICAL FIELD

This invention relates to springs used to provide flexibility among platforms/layers where they are located.

In particular the invention relates to suspension pocket spring system produced for use in manufacture of bed inner construction systems.

### BACKGROUND OF THE ART

Today springs of various sizes made of various materials are used in several fields. The springs provide flexibility of the platforms where they are located. When pressure is applied onto the platform, it is compressed and provides energy collection. During that time it also tries to oscillate. When the pressure thereon starts to reduce it starts to oscillate. The oscillation continues until all energy accumulation occurred after compression is discharged. Regardless of the material they are made of, the springs lose their functions due to deformation after a certain number of oscillations.

In the patent document numbered GB734949, the invention relates to spiral/helical springs located between two layers for use in floor covering and beds. The said springs are located between two layers formed with knitting process for use in floor covering or beds. As mentioned above, it loses its function and is deformed after a certain number of oscillations since the resistance is low.

Again, the invention under the patent no GB2403902 entitled “Mattress comprising both pocketed and open springs” relates to a spring unit consisting of multi pocketed springs having flexible structure in enclosed pack form made of garment or other materials and open springs located between the said multi pocketed springs. The said pocketed and open springs are preferably made of spiral springs. The said invention contains pocketed springs used between the said springs. The springs used in the pocketed springs and other springs used in between are manufactured and used in the same size and intensity.

The invention under the patent no FR2861270 entitled “Helical spring string for spring suspension of bedding mattress, has retention pockets, each containing two helical springs that are connected via central coil having smaller diameter and produced with same metallic wire” relates to a spring embodiment containing holder pocket consisting of two interconnected helical springs. The said helical springs are interconnected at the centers where the diameters are smaller. Both helical springs are made of uninterrupted identical metal materials. The helical springs in the same pocket have identical or different rigid structure. The spring embodiment of the said invention is composed of those springs in the pocket form. Improvement in the said embodiment is possible.

The invention of the U.S. Pat. No. 6,256,820 entitled “Multilayered pocketed bedding or seating product” relates to bedding or seating product comprising a spring core made up of a plurality of parallel strings of springs joined to each other. Each of the strings of springs comprises a row of interconnected pocketed coil springs. The pocket of fabric surrounding each of these coil springs is divided into at least two sub pockets by at least one line of attachment of opposite sides of the fabric to each other. Each of these sub pockets contains one portion of the coil spring, thus resulting in a multilayered product. Flexibility resistance increase has been provided in this way but entire of the embodiment consists of pockets of the same features, which increases manufacture cost and causes manufacture of heavier material. The desired plane homogeneity is not provided either.

The invention under U.S. Pat. No. 6,397,418B1 entitled “Double spring mattress and manufacturing process” relates to a spring plane containing two springs layer reinforced inside a cover and production of it. The springs of the upper layer are located over the springs having structure appropriate to the structure inside the lower layer. The springs used for flexibility resistance of the said structure are two parts located in an enclosed structure in pocket form.

The invention under the U.S. Pat. No. 6,523,812 entitled “Spring Units” relates to a spring unit for use in a sprung unit such as a bed, mattress, the spring unit comprising a pocket of fabric or other suitable material and having at least two sub-pockets, each of said sub-pockets containing a resilient member. The pocket will preferably be divided across, laterally, or diagonally so as to form said at least two sub-pockets. The sub-pockets may be of equal length or of differing lengths. The said pocket is divided by fabric or other convenient materials. In this invention, although the said pocket spring is composed of two parts within itself, it does not have a separate and partial structure. It is a pocketed spring composed of two interconnected spring parts.

As seen from the samples given above and FIG. 1, in the embodiment of the related art either a single type spring embodiment is used and pocketed springs are located between the single type springs. The said pocketed springs consist of single or part embodied springs. Both excess materials is used and it does not respond to the body ergonomics as requested. For that reason, the embodiment does not offer an equal distribution in response to weight and height of the person using it, the embodiments fail to offer ergonomics and comfort.

As a result it has been necessary to make development in the related art due to existence of need for a suspension pocketed spring system having separate structure for use in manufacture of inner construction systems of bed and inadequacy of the existing solutions.

### PURPOSE OF THE INVENTION

From the status of the related art, the purpose of the invention is to provide appropriate respond to body ergonomics in order to eliminate the disadvantages of the related art.

Another purpose of the invention is to offer equal sensitivity to weight and height differences of users.

A further purpose of the invention is to prolong the life by help of the resistance structure.

Another purpose of the invention is that it does not impact the body ergonomics since equal distribution is provided on both sides of the embodiment when compared to partial structural applications.

A further purpose of the invention is to reduce the cost with help of manufacture technique.

Another purpose of the invention is to provide resistance and long life of materials used with help of resistance structure.

Another purpose of the invention is to provide lower use cost with help of long life.

A further purpose of the invention is to offer higher preference in the materials used with help of resistance and long life.

The structural and characteristic features and all advantages of the invention will be better understood with the figures given below and detailed description with reference to be made to them and therefore, the assessment should be made taking into consideration the said figures and detailed description.

### DESCRIPTION OF THE FIGURES

FIG. 1 Perspective view of the spring system of the related art,

FIG. 2 perspective view of the embodiment of the pocketed spring system being subject of the invention,

FIG. 2a view of pocketed spring system (standard pocket springs) of the invention,

FIG. 2b View of pocketed spring system (short pocketed springs) of the invention,

FIG. 3a View of 1. joining stage of the pocketed spring system of the invention,

FIG. 3b View of the 2. joining stage of the pocketed spring system of the invention,

FIG. 3c Side perspective view of the pocketed spring system of the invention after joining,

FIG. 4 View of final form and application after manufacture of the invention.

### REFERENCE NUMBERS

Y. Spring,
10. Standard pocketed spring,
11. Standard pocketed spring side surface,
20. Short pocketed spring,
21. Upper short pocketed spring,
   21.1 Upper pocket sub surface,
   21.2 Upper pocket side surface,
22. Lower short pocket spring,
   22.1 Lower pocket upper surface,
   22.2 Lower pocket side surface,
23. Space,

### DETAILED DESCRIPTION OF THE INVENTION

The invention is a suspension pocketed spring system having separate structure manufactured for use in inner construction system of bed used to provide flexibility between platforms/layers where it is located, and manufacturing method.

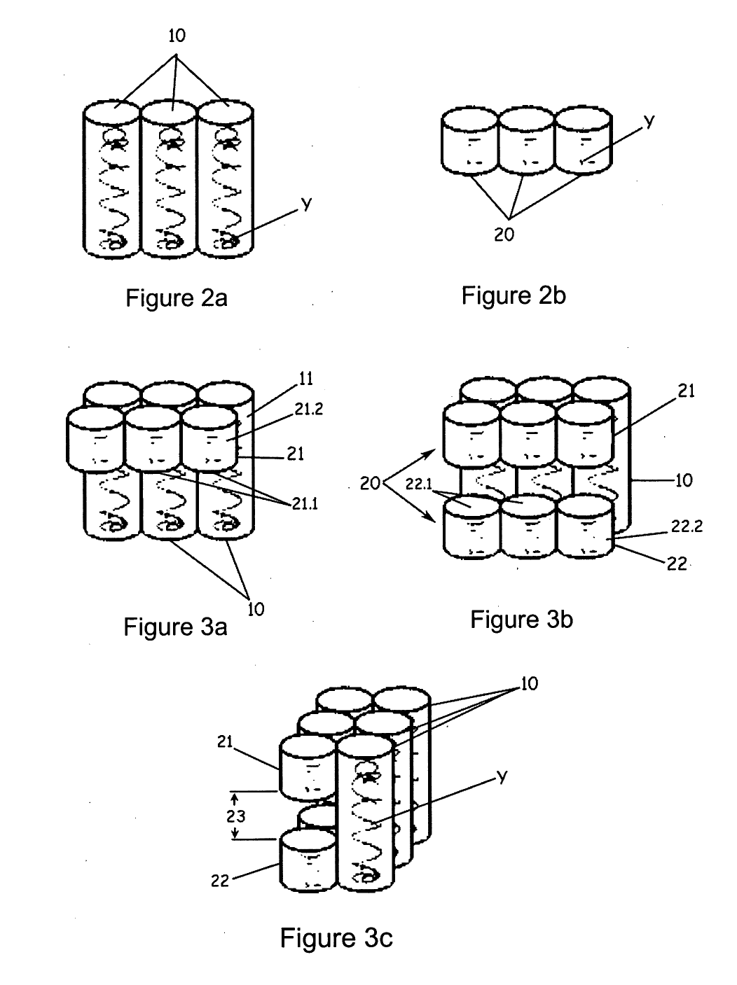

FIG. 2 shows perspective view of the pocketed spring system of the invention. As seen in the figure, standard pocketed springs (10) and short pocketed springs (20) located in between to increase the resistance and flexibility are seen. The said short pocketed springs (20) are mounted as connected to standard pocketed springs (10) separately on each other to form the spring system.

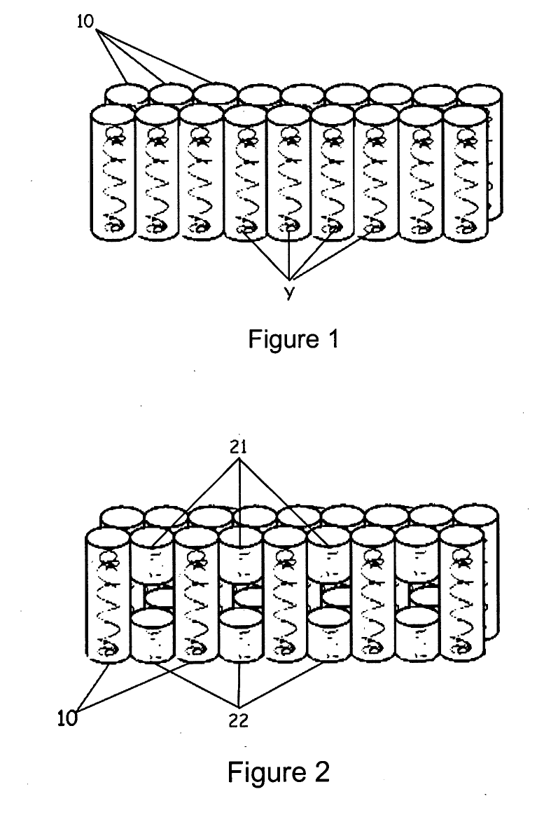

FIG. 2a shows view of pocketed spring system of the invention (standard pocketed springs (10)). The said standard pocketed springs (10) are produced in strip form at manufacturing machine and cut in requested sizes and are joined together by means of adhesives. Thus, the standard spring system of the related art shown in FIG. 1 is obtained. The said standard pocketed springs (10) is made of a fabric or another convenient material composed of a spring (Y) located therein.

FIG. 2b shows view of the pocketed spring system (short pocketed springs (20)) of the invention. As seen in the figure, the said short standard springs (20) are cut in requested sizes after manufacturing. Upper and lower short pocketed spring (21, 22) are located between the standard pocketed springs (10).

FIG. 3a shows view of 1. joining stage of pocketed spring system of the invention. Upper short pocketed springs (21) are glued to upper parts of the side surfaces (11) of the standard pocketed springs (10) from side surfaces (21.2).

FIG. 3b shows view of 2. joining stage of pocketed spring system of the invention. According to the figure, upper short pocketed springs (21) are connected to standard pocketed springs (10) and then lower short pocketed springs (22) are connected to the said standard springs (10) by means of gluing. The said lower short pocketed springs (22) are connected to the lower parts of the standard pocketed side surfaces (11) from side surfaces (22.2). As seen in the figure, the standard pocketed springs (10) connected by means of gluing to the said short pocketed springs (21, 22) are glued to each other side by side.

A space (23) is provided between lower short pocketed springs (22) upper surfaces (22.1) and upper short pocketed springs lower surfaces (21.1) after joining in a manner they do not contact each other. The flexibility resistance is increased with help of the said space (23), ergonomics is provided as a result of easily taking form of the body.

FIG. 3c shows side perspective view of pocketed spring system of the invention after connection. As seen in the figure, standard pocketed springs (10) and short pocketed springs (20) connected under and above of them. In addition, the space (23) between the said short pocketed springs (20) is seen.

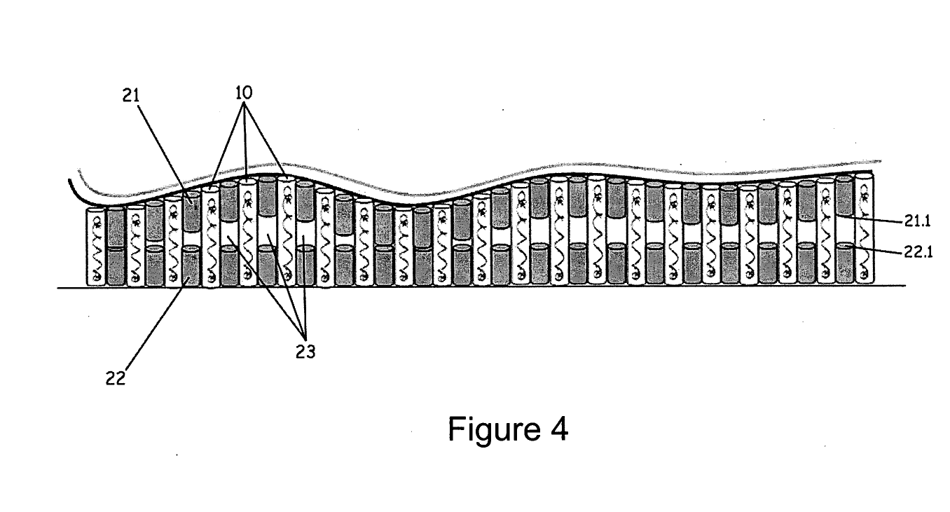

FIG. 4 shows view of final form and application after manufacture of the invention. As seen in the figure upon the pressure applied in the form of body during use, the pocketed spring system takes form of the body. The short pocketed springs (20) composing the said pocketed spring system and spaces (23) formed between them provide the advantage of ergonomics.

The protection scope of this patent application has been specified under the claims and can never be limited to the descriptions provided for sampling. It is obvious that any person skilled in the related art may suggest the innovation claimed under this invention by use of similar embodiments and/or may apply this embodiment to other arts used for similar purposes in the related art. Therefore, it is obvious that such embodiments will lack innovation and particularly exceeding the background of the related art.

1. A method of forming a suspension pocketed spring system comprising the steps of:
providing standard pocketed springs manufactured for use in inner construction systems of beds used to provide flexibility between platforms/layers where the pocketed springs are to be located; and
connecting short pocketed springs with the standard pocketed springs, wherein the short pocketed springs are separated from each other in a manner such that a space is formed between them.

2. The method according to claim 1, wherein upper short pocketed springs are adhered to upper parts of side surfaces of the standard pocketed springs from side surfaces.

3. The method according to claim 1, wherein lower short pocketed springs are connected to lower parts of the side surfaces of the standard pocketed springs from side surfaces.

4. The method according to claim 1, wherein the standard springs connected by means of joining the said upper and lower short pocketed springs are combined by means of adhesion of other standard springs and short pocketed springs connected in the same manner.

5. The method according to claim 1, wherein a space is formed in a manner the upper surfaces of the said lower short pocketed springs and lower surfaces of the said upper short pocketed springs face each other.

6. A suspension pocketed spring system comprising:
standard pocketed springs manufactured for use in inner construction systems of beds to provide flexibility between platforms/layers where the pocketed springs are to be located, and
short pocketed springs connected to said standard pocketed springs in a manner to form a space between the short pocketed springs after connection of the said short pocketed springs to the standard pocketed springs.

7. The suspension pocketed spring system according to claim 6, wherein said short pocketed springs comprise an upper short pocketed spring and a lower short pocketed spring.

8. The suspension pocketed spring system according to claim 7, wherein said upper short pocketed spring comprises a lower surface, and wherein said lower short pocketed spring comprises an upper surface, and wherein said space is located between the upper surface of the lower short pocketed spring and the lower surface of the upper short pocketed spring.

9. The suspension pocketed spring system according to claim 7, wherein said upper and lower pocketed springs comprise side surfaces connected to said standard pocketed springs.
